(19) United States
(12) Patent Application Publication
(10) Pub. No.: US 2025/0225706 A1
(43) Pub. Date: Jul. 10, 2025

(54) GENERATIVE HUMAN MOTION SIMULATION WITH TEMPORAL CONTROL

(71) Applicant: NVIDIA Corporation, Santa Clara, CA (US)

(72) Inventors: Mathis PETROVICH, Zurich (CH); Xue Bin PENG, Vancouver (CA); Davis REMPE, Redwood City, CA (US); Umar IQBAL, Danville, CA (US); Or LITANY, Sunnyvale, CA (US); Sanja FIDLER, Toronto (CA)

(21) Appl. No.: 18/404,758

(22) Filed: Jan. 4, 2024

(51) Int. Cl. G06T 13/40; G06T 5/50; G06T 5/70

(52) U.S. Cl. CPC G06T 13/40; G06T 5/50; G06T 5/70; G06T 2207/20221

(57) ABSTRACT

In various examples, a timeline of text prompt(s) specifying any number of (e.g., sequential and/or simultaneous) actions may be specified or generated, and the timeline may be used to drive a diffusion model to generate compositional human motion that implements the arrangement of action(s) specified by the timeline. For example, at each denoising step, a pre-trained motion diffusion model may be used to denoise a motion segment corresponding to each text prompt independently of the others, and the resulting denoised motion segments may be temporally stitched, and/or spatially stitched based on body part labels associated with each text prompt. As such, the techniques described herein may be used to synthesize realistic motion that accurately reflects the semantics and timing of the text prompt(s) specified in the timeline.

### BACKGROUND

Human character motion (or simply human motion) simulation (and the generation thereof) typically seeks to create realistic and natural movements for virtual or animated characters that mimic the way humans move in the real world. For example, human motion simulation may attempt to simulate the complex interplay of joints, muscles, and/or physical constraints to produce lifelike animations. Human motion simulation often plays a central role in computer graphics, animation, and/or virtual reality techniques, as it can add a layer of authenticity and immersion to digital experiences in various industries and applications, such as video games, film and television production, simulation training, healthcare (e.g., for physical therapy simulations), and/or other scenarios. For example, in the entertainment industry, human motion simulation can enable the creation of compelling and believable characters, enhancing the overall viewing experience. In the context of training or design simulations, human motion simulation can allow professionals to practice or design in a controlled environment without real-world risks. In healthcare, human motion simulation can aid in rehabilitation and recovery by providing patients with interactive exercises tailored to their specific needs. These are just a few examples in which human motion simulation can help bridge the gap between the digital and physical worlds.

Conventional techniques for generating human motion simulation (“generative human motion simulation”) have a variety of drawbacks. For example, some existing techniques attempt to synthesize a fixed duration of human motion from a single text prompt. However, due to a lack of representative training data, conventional techniques struggle to synthesize compositional motion from complex text prompts that specify sequential actions (temporal composition of multiple acts of motion) and/or simultaneous actions (spatial composition of simultaneous acts of motion).

Consider an input prompt such as: “A human walks in a circle clockwise, then sits, simultaneously raising their right hand towards the end of the walk, the hand raising halts midway through the sitting action.” This prompt includes temporal composition since it specifies multiple actions that should be performed in sequence (e.g., walking then sitting) and spatial composition since it specifies several actions that should be performed simultaneously with different body parts (e.g., walking while raising hand). Conventional techniques are unable to handle complex prompts like this, and often generate motion that does not reflect or resemble reasonable human behavior in the real world, or motion that does not adequately execute the prompt. Furthermore, lengthy text prompts often become unwieldy and difficult for users to specify with precision, so many detailed text prompts are ambiguous about the timing and duration of the intended actions. This also results in many unintended and unrealistic animations. As such, conventional text-to-motion generation techniques lack precise animation controls that are crucial for many animators. For these and other reasons, there is a need for improved generative human motion simulation techniques.

### SUMMARY

Embodiments of the present disclosure relate to timeline control of generative human motion simulation. Systems and methods are disclosed that iteratively denoise a motion sequence based on an arrangement of text prompts specified in a timeline. In contrast to conventional systems, such as those described above, a timeline of text prompt(s) arranging any number of (e.g., sequential and/or simultaneous) actions may be specified or generated, and the timeline may be used to drive a diffusion model to generate compositional human motion that implements the arrangement of action(s) specified by the timeline. For example, at each denoising step, a pre-trained motion diffusion model may be used to denoise a motion segment corresponding to each text prompt independently of the others, and the resulting denoised motion segments may be temporally stitched, and/or spatially stitched based on body part labels associated with each text prompt. As such, the techniques described herein may be used to synthesize realistic motion that accurately reflects the semantics and timing of the text prompt(s) specified in the timeline.

### BRIEF DESCRIPTION OF THE DRAWINGS

The present systems and methods for temporal control of generative human motion simulation are described in detail below with reference to the attached drawing figures, wherein:

FIG. 1 is a block diagram of an example temporally-conditioned motion generation pipeline, in accordance with some embodiments of the present disclosure;

FIG. 2 illustrates an example timeline of text prompts, in accordance with some embodiments of the present disclosure;

FIG. 3 illustrates an example technique for labeling text prompts with corresponding body parts and body part partitioning of a timeline, in accordance with some embodiments of the present disclosure;

FIG. 4 illustrates an example technique for expanding temporal intervals and identifying transition intervals associated with a timeline of text prompts, in accordance with some embodiments of the present disclosure;

FIG. 5 illustrates an example technique for temporally-conditioned denoising of a motion sequence, in accordance with some embodiments of the present disclosure;

FIG. 6 is a flow diagram illustrating a method of generating a representation of a motion sequence of a character corresponding to a timeline, in accordance with some embodiments of the present disclosure;

FIG. 7 is a flow diagram illustrating a method of denoising a motion sequence, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed related to temporal control of generative human motion simulation. In some embodiments, a timeline of text prompt(s) specifying any number of (e.g., sequential and/or simultaneous) actions may be specified or generated, and the timeline may be used to drive a diffusion model to generate compositional human motion that implements the arrangement of action(s) specified by the timeline. Although some embodiments of the present disclosure involve simulation of human motion, this is not intended to be limiting. For example, the systems and methods described herein may be used to simulate motion of any articulated object, such as biological objects (e.g., humans, animals, etc.), robots (e.g., humanoid, animatronic, etc.), articulated vehicles or machines (e.g., construction equipment like excavators, industrial arms, articulated telescopes), etc.

In some embodiments, a graphical user interface accepts input representative of an arrangement (or modifications thereto) of any number of text prompts on a timeline. This type of timeline interface provides an intuitive, fine-grained, input interface for animators. In some embodiments, instead of a single text prompt, the timeline interface may accept a multi-track timeline comprising multiple text prompts arranged in corresponding temporal intervals that may overlap. This type of timeline interface enables users to specify the exact timing for each desired action, to compose multiple actions in sequence, and/or to compose multiple actions in overlapping temporal intervals. In some embodiments, any pre-trained motion diffusion model may be used to generate composite animations from a multi-track timeline. In an example embodiment, at each denoising step, a pre-trained motion diffusion model may be used to denoise each timeline interval (text prompt) individually, and the resulting prediction may be aggregated over time based on the body parts engaged in each action. As such, the techniques described herein may be used to synthesize realistic motion that accurately reflects the semantics and timing of the text prompt(s) specified in the timeline.

Multi-track temporal control for text-driven motion synthesis is a generalization of several motion synthesis tasks, and therefore brings many additional challenges to the task of realistic motion simulation. For example, a multi-track temporal input may support specifying a single interval (i.e., duration) with a single textual description (text-to-motion synthesis), specifying a temporal composition of a sequence of text prompts that describe a sequence of actions to be performed in non-overlapping intervals, and/or specifying a spatial composition of a set of text prompts that describe actions to be performed simultaneously with different body parts. Solving this task is difficult due to the lack of training data containing complex compositions and long durations. For example, depending on the embodiment, a temporally-conditioned diffusion model may need to handle a multi-track input containing several prompts, rather than a single text description. Moreover, the diffusion model may need to account for both spatial and temporal compositions to ensure seamless, realistic transitions, unlike prior work that has addressed either of these individually. Additionally or alternatively, some embodiments may relax the assumption of a limited duration (e.g., less than 10 seconds) made by many recent text-to-motion approaches.

To address these challenges, some embodiments implement spatial and/or temporal stitching within an iterative denoising process in which a motion diffusion model may iteratively predict and refine a diffused motion sequence over a series of diffusion steps. To accommodate a lack of appropriate training data, some embodiments may operate a pre-trained (e.g., off-the-shelf) motion diffusion model at test time. In each diffusion step, each text prompt in the timeline may be denoised independently of the other text prompts to predict a denoised motion segment for each corresponding interval, and these independently generated motion segments may be stitched together in both space and time before continuing on to the next denoising step. To facilitate spatial stitching of overlapping motion segments for different body parts, in some embodiments, text prompts specified by the timeline may be assigned to corresponding body parts (e.g., using heuristics, a large language model, etc.), motion segments for different body parts may be extracted from full-body motion segments generated from corresponding text prompts, and the motion segments for the different body parts may be concatenated. To facilitate temporal stitching, text prompts specified by the timeline may be expanded to overlap with adjacent intervals, noised motion segments corresponding to the expanded intervals may be independently denoised conditioned on a corresponding text prompt, and predicted scores of overlapping conditioned motion segments and a corresponding unconditioned motion segment may be combined to guide the subsequent denoising step. In some embodiments, text prompts specified by the timeline may be assigned to corresponding body part tracks on the timeline, and temporal stitching may be applied to smooth the (e.g., expanded) denoised motion segments within each body part track prior to stitching the motion segments for the different body parts represented by the different body part tracks.

In an example implementation, any number of text prompts may be arranged on a first multi-track timeline. Upon receiving an instruction to generate motion based on the timeline, the specified text prompts may be assigned to corresponding body part tracks (e.g., legs, torso, neck, left arm, right arm) on a second multi-track (body part) timeline (e.g., using a large language model), and unassigned segments in body part tracks on the body part timeline may be assigned text prompts from another body part track (e.g., using heuristics). For example, a text prompt that instructs a character to walk may be assigned to a body part track representing actions to be performed by the character's legs, and if there are no other overlapping actions during that text prompt, the text prompt may also be assigned to tracks representing actions to be performed by the character's other body parts. Each of the intervals specified by the first and second timelines may be expanded to overlap with adjacent intervals, and the resulting timelines may be used to drive an iterative denoising process. In each denoising step, the individual motion segments specified by the first timeline may be segmented or cropped from the full timeline, independently denoised, and recombined. More specifically, the denoised motion segments may be assigned to corresponding body part tracks on the body part timeline, the denoised motion segments within each body part track may be temporally stitched, and motion segments for different body parts may be extracted from the stitched denoised motion segments represented by corresponding body part tracks and concatenated to reconstitute the denoised output for the full timeline for that denoising step.

As such, in each diffusion step, the diffusion model may independently predict a diffused motion sequence for each motion segment, the resulting diffused motion segments may be spatially and/or temporally stitched according to the timeline, and the diffusion model may diffuse the resulting diffused motion sequence for the entire timeline back to the previous diffusion step, effectively updating the state of the denoised motion sequence based on the timeline in reverse order from the final diffusion step to the initial one. By beginning with the most refined representation of motion and diffusing it back to the previous step, the diffused timeline-specified motion sequence predicted in each diffusion step benefits from the accumulated improvements made in later steps, improves timeline-specified temporal dependencies where a later state may be influenced by a previous state, and provides an opportunity to correct any errors or inaccuracies introduced in earlier steps, resulting in a more accurate and realistic timeline-specified motion sequence.

As such, the techniques described herein may be utilized to generate precise and realistic simulated human motion for a character based on a timeline that arranges text specifying any number of (e.g., overlapping and/or simultaneous) actions for the character. The timeline input makes text-to-motion generation more controllable than in prior techniques, giving users fine-grained control over the timing and duration of actions while maintaining the simplicity of natural language. Furthermore, unlike prior techniques, the compositional denoising process described herein enables pre-trained diffusion models to handle the spatial and temporal compositions present in timelines, facilitating an accurate execution of all prompts in the timeline.

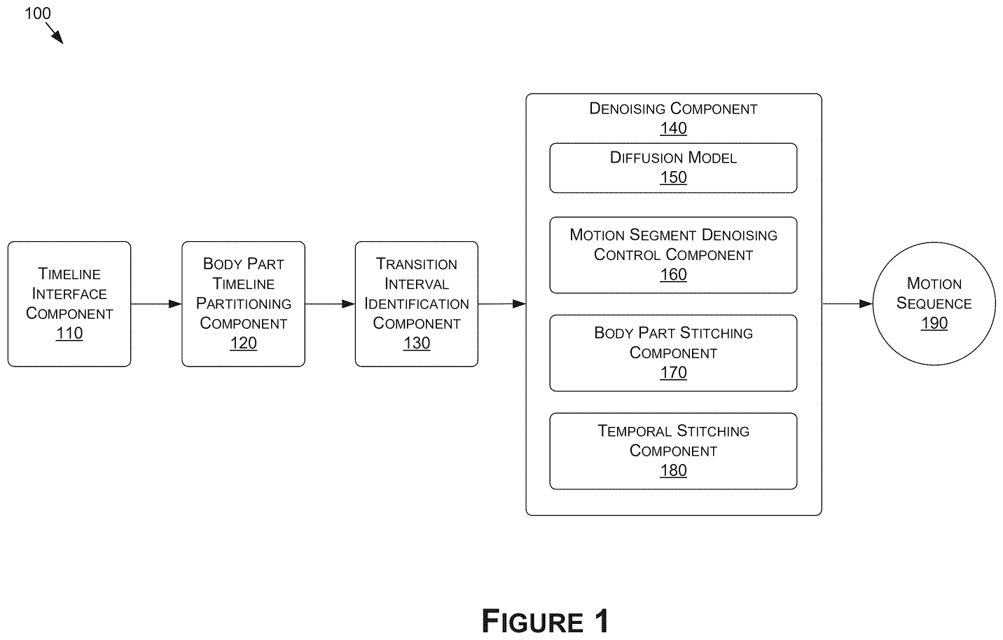

With reference to FIG. 1, FIG. 1 is an example temporally-conditioned simulated motion generation pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

At a high level, the temporally-conditioned simulated motion generation pipeline 100 may include, be incorporated into, or be triggered by a user interface for a character animation, robotics, and/or other type of application that generates a representation of and/or animates motion, and the user interface may accept one or more user inputs representing an instruction for a character, robot, or other entity. More specifically, the user interface may accept input specifying one or more instructions (e.g., text prompts) describing any number of (e.g., sequential and/or simultaneous) actions for a character, and the temporally-conditioned simulated motion generation pipeline 100 may generate a representation of a motion sequence 190 for the character following the applicable instruction(s) specified for each temporal interval. For example, a motion sequence x lasting N time steps may be represented as a sequence of pose vectors x=(x¹, . . . , x^{N}) representing poses at N corresponding waypoints, where each pose xⁱ∈ [symbol] ^{d}. Any suitable pose representation may be used. In some embodiments, each pose may represent positions, rotations, and/or velocities of any number of joints (e.g., root joint velocity; local joint positions, rotations, and/or velocities). In some embodiments, a pose representation such as Skinned Multi-Person Linear Model (SMPL) may be used. As such, the generated motion sequence 190 may represent positions and orientations for a plurality of joints in a skeletal structure of the character being animated, for each of the waypoints. As such, in this example, the temporally-conditioned simulated motion generation pipeline 100 may use these positions and orientations to generate an animation of the body of the character as it advances through the waypoints of the motion sequence 190.

In the example illustrated in FIG. 1, the temporally-conditioned simulated motion generation pipeline 100 includes a timeline interface component 110, a body part timeline partitioning component 120, a transition interval identification component 130, and a denoising component 145 comprising a diffusion model 150. At a high level, the timeline interface component 110 may accept input representative or corresponding to an arrangement (or modification thereto) of any number of text prompts on a timeline, the body part timeline partitioning component 120 may label, assign, or otherwise associate an applicable body part with each text prompt, partition the timeline into different tracks for different body parts, and populate the resulting body part tracks with applicable text prompts based on corresponding body part labels. The transition interval identification component 130 may expand the temporal intervals corresponding to each of the text prompts so adjacent intervals overlap, and may identify transition intervals comprising the expanded portions of the intervals on the timeline. As such, the denoising component 145 may implement an iterative denoising process using the diffusion model 150 to independently denoise motion segments corresponding to each expanded interval, temporally and/or spatially stitch the resulting denoised motion segments together, and iterate over any number of diffusion steps to generate the motion sequence 190 (e.g., a spatio-temporal motion collage).

At a high level, the timeline interface component 110 may implement a graphical user interface that exposes a multi-track timeline and accepts input arranging any number of text prompts in corresponding temporal intervals that may overlap. Generally, the timeline interface component 110 may include any suitable interaction element or other feature that facilitates input, arrangement, and editing of text prompts in any number of tracks, such as track controls (e.g., creating, deleting, naming tracks), visual representation of the timeline, motion segment arrangement and editing (e.g., creating and deleting intervals representing motion segments in tracks, handle adjustment or other method of specifying start and stop times for motion segment boundaries, entering text prompts into corresponding motion segments, drag-and-drop functionality within and between tracks, standard editing operations such as cut, copy, and paste), navigational features (e.g., scrubbing, zoom options), and/or other timeline or graphical user interface features.

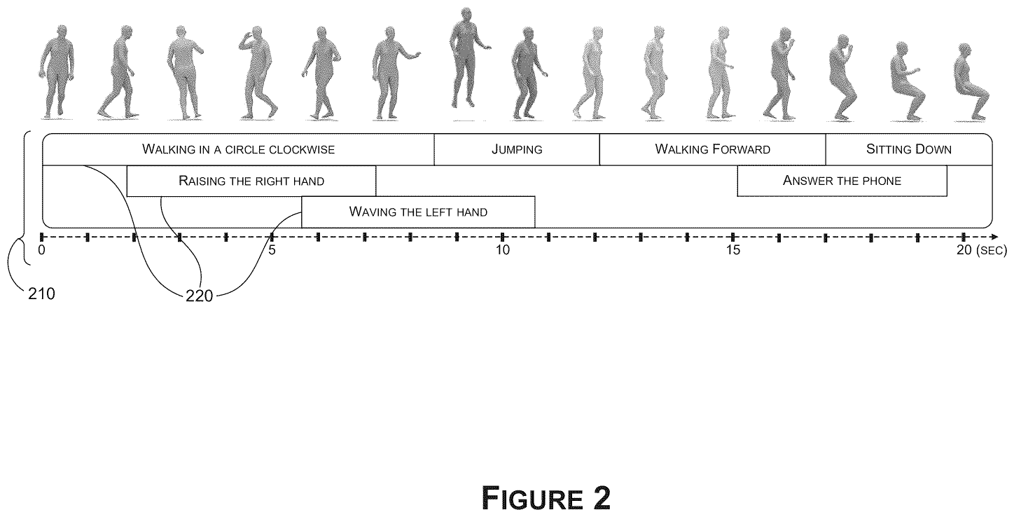

FIG. 2 illustrates an example timeline 210 of text prompts 220, in accordance with some embodiments of the present disclosure. Generally, the timeline 210 provides precise, multi-track temporal control for text-driven generative human motion simulation. More specifically, a user may provide a structured and intuitive timeline 210 of text prompts 220 as input, using any number of potentially overlapping temporal intervals. Each specified temporal interval may correspond to a precise textual description of a particular type of motion for a character to perform. As such, the complex compositional prompts become much simpler to specify within the timeline 210 and provide animators with improved controls to specify the timing of each desired action.

In the example illustrated in FIG. 2, the timeline 210 accepts input defining multiple temporal intervals, where each interval is linked to a natural language prompt describing a desired human motion for the character to perform during a corresponding portion of an animation. For the j^{th} prompt in the timeline 210, its temporal interval may be represented as [aⱼ,bⱼ] and the corresponding prompt may be represented as Cⱼ. The intervals may be arranged and visually represented in a multi-track layout on the timeline 210, permitting overlaps. The duration of each interval and/or the overall timeline may be configurable, and in some embodiments, the timeline 210 may be associated with any number of interaction elements providing corresponding controls that accept input adding an arbitrary number of tracks (e.g., rows) to the timeline 210 (although, in practice, a character may only be able to perform a few actions simultaneously). In some embodiments, a large language model (e.g., OpenAI's GPT-4, Anthropic's Claude 2, HuggingFace's HuggingChat, etc.) may be used to test overlapping text prompts for compatibility, and if the large language model identifies incompatible overlapping text prompts, a user interface may prompt the user to resolve the conflict.

In the example illustrated in FIG. 1, the temporally-conditioned simulated motion generation pipeline 100 accepts user input arranging the motion segments on a timeline, but this need not be the case. In some embodiments, the temporally-conditioned simulated motion generation pipeline 100 may accept a single text prompt describing a temporal composition of multiple acts of motion and/or a spatial composition of simultaneous acts of motion, the temporally-conditioned simulated motion generation pipeline 100 may append the text prompt to an instruction to generate a timeline of motion segments based on the text prompt, and may apply the instruction to a large language model to extract constituent text prompts and start and stop times for constituent motion segments. In some embodiments, in-context learning may be used to provide the large language model with any number of examples of how to decompose a text prompt.

In the example illustrated in FIG. 1, the temporally-conditioned simulated motion generation pipeline 100 accepts user input specifying an instruction embodied in natural language via one or more text prompts, however, a variety of inputs are possible, depending on the implementation. The temporally-conditioned simulated motion generation pipeline 100 may include, be incorporated into, or be triggered by a user interface that accepts and/or encodes an instruction represented in a voice command, a detected gesture, joystick or gamepad input, virtual or augmented reality controller(s), and/or other type of input, and the temporally-conditioned simulated motion generation pipeline 100 may transcribe, decode, map, and/or otherwise generate a text prompt from a corresponding instruction. These are just a few examples, and other variations may be implemented within the scope of the present disclosure.

In some embodiments, the body part timeline partitioning component 120 may label, assign, or otherwise associate an applicable body part with each text prompt specified by the timeline, partition the timeline into different tracks for different body parts, and populate the resulting body part tracks with applicable text prompts based on corresponding body part labels. More specifically, to facilitate spatial stitching, upon receiving (e.g., via an interaction element) an instruction to generate an animation based on a timeline of arranged text prompts, the body part timeline partitioning component 120 may pre-process the timeline to assign a text prompt to each of a plurality of body part tracks (representing supported body parts) for every temporal interval on the timeline, thereby creating a separate body part timeline for each supported body part (e.g., left arm, right arm, torso, legs, head). As such, each body part track may be thought of as its own body part timeline.

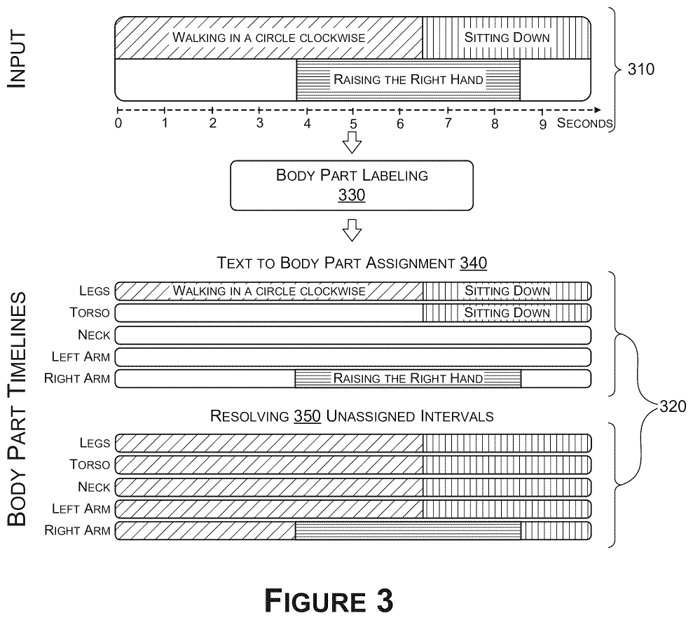

FIG. 3 illustrates an example technique for labeling text prompts with corresponding body parts and body part partitioning of a timeline 310, in accordance with some embodiments of the present disclosure. For example, in body part labeling 330, each text prompt in the timeline 310 may be annotated (e.g., by the body part timeline partitioning component 120 of FIG. 1) with an applicable body part involved in the motion described by a corresponding text prompt. For example, the text prompt “walking in a circle clockwise” involves the legs, so that prompt may be annotated with a “legs” label. “Raising the right hand” involves the right hand, so that prompt may be annotated with a “right hand label.” Identification of applicable body part labels may be done automatically (e.g., by querying a large language model to assign a label to the text prompt, using a retrieval model to match the prompt with a corresponding label) or directly based on user input (e.g., directly assigning body part labels to text prompts). In an example embodiment, labels for representative body parts such as left arm, right arm, torso, legs, and neck/head may be supported, but in some embodiments, a label (and corresponding body track) for any body part may be supported.

In text to body part assignment 340, the body part labels may be used (e.g., by the body part timeline partitioning component 120 of FIG. 1) to assign the text prompts to corresponding body part timelines 320 for each supported body part. To fill in the remainder of the body part timelines 320 where body parts have not been assigned to a text prompt, unassigned intervals may be resolved 350 (e.g., by the body part timeline partitioning component 120 of FIG. 1) using any number of heuristics. For example, in some embodiments, the body part timelines 320 may be cut, partitioned, segmented, or boundaries may be otherwise identified for segments for which no new text prompts appear or disappear within each segment (e.g., by identifying segments formed by the union of all temporal boundaries for all the text prompts). For each segment, a base text prompt may be identified (e.g., based on some priority criterion such as a prompt involving the legs or having the maximum number of applicable body parts, based on random selection, etc.), the base text prompt may be assigned to all the body part timelines 320, other text prompts present in the segment may be sorted (e.g., by decreasing order of the number of applicable body parts), labels for the other text prompts present in the segment may be used to override the assignment for the applicable body part timelines (e.g., in the sorted order), and the body part timelines 320 may be regrouped (e.g., removing cuts to reconstitute the full timelines). As such, the body part timelines 320 may be filled with applicable text prompts.

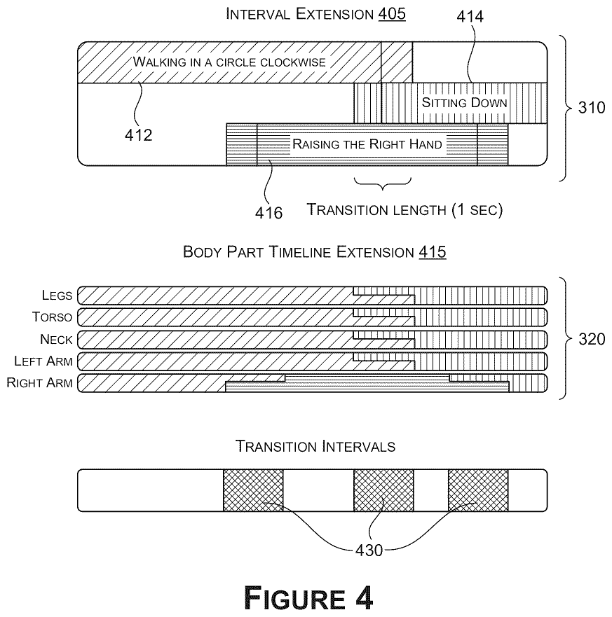

Returning to FIG. 1, in some embodiments, the transition interval identification component 130 may expand the temporal intervals corresponding to each of the text prompts so adjacent intervals overlap, and may identify transition intervals comprising the expanded portions of the intervals on the timeline. FIG. 4 illustrates an example technique for expanding temporal intervals and identifying transition intervals 430 associated with the timeline 310 of text prompts 412, 414, 416, in accordance with some embodiments of the present disclosure. For example, in interval extension 405, each of the temporal intervals corresponding to the text prompts 410, 414, 416 may be expanded or extended a designated duration (e.g., 0.5 seconds). An expanded temporal interval may be denoted as [aⱼ−l,bⱼ+l], where l is the designated expanded or extended duration for each interval. In body part timeline extension 415, each of the body part timelines 320 may be extended a corresponding duration to overlap. As such, the overlapping intervals of the extended text prompts on the timeline 310 and/or on the body part timelines 320 may be identified as the transition intervals 430.

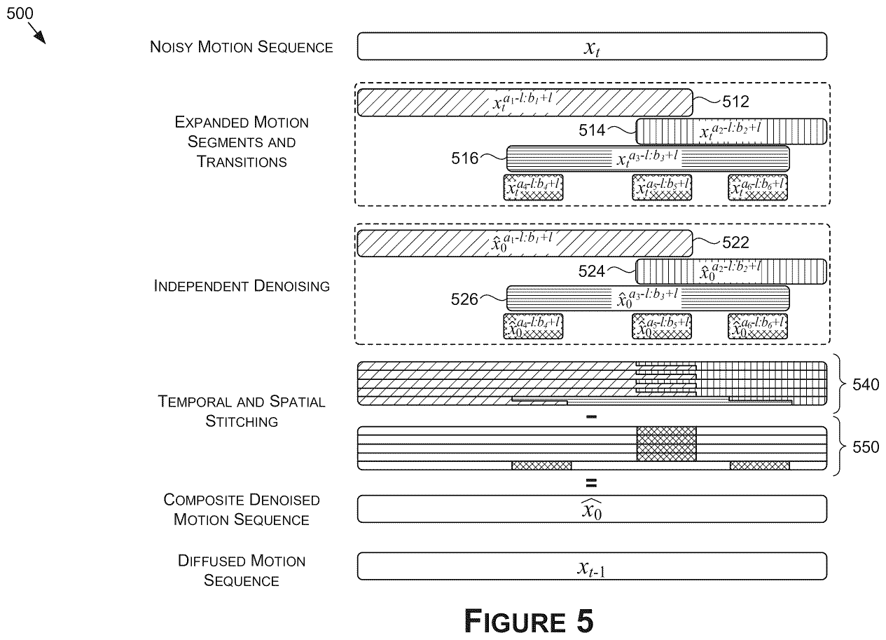

Returning to FIG. 1, in some embodiments, the denoising component 145 may implement an iterative denoising process using the diffusion model 150 to independently denoise motion segments corresponding to each expanded interval, temporally and/or spatially stitch the resulting denoised motion segments together, and iterate over any number of diffusion steps to generate the motion sequence 190 (e.g., a spatio-temporal motion collage). In an example implementation, the denoising component 145 may operate the diffusion model 150 only at test time, enabling an off-the-shelf, pre-trained diffusion model to generate motion conditioned on a multi-track timeline. At each denoising step, the denoising component 145 may accept as input the current noisy motion sequence xₜ encapsulating the entire timeline and may output a corresponding denoised motion sequence \hat{x}₀. In the example illustrated in FIG. 1, the denoising component 145 includes a motion segment denoising control component 160, a body part stitching component 170, and a temporal stitching component 180. As illustrated in FIG. 5, the motion segment denoising control component 160 may use the diffusion model 150 to independently predict a denoised motion segment corresponding to each of the input text prompts. These predictions may be stitched together spatially by the body part stitching component 170 using the corresponding body part annotations for each text prompt, and/or stitched in time by the temporal stitching component 180 to ensure the denoised motion smoothly spans the entire timeline. The resulting composite denoised motion sequence may be used as the output \hat{x}₀ of the current denoising step, which the denoising component 145 may use to sample xₜ₋₁ and continue the denoising process.

In some embodiments, the diffusion model 150 may be implemented using neural network(s). Although the diffusion model 150 and other models and functionality described herein may be implemented using a neural network(s) (or a portion thereof), this is not intended to be limiting. Generally, the models and/or functionality described herein may be implemented using any type of a number of different networks or machine learning models, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, transformer, recurrent, perceptrons, Long/Short Term Memory (LSTM), Hopfield, Boltzmann, deep belief, de-convolutional, generative adversarial, liquid state machine, etc.), and/or other types of machine learning models.

Generally, motion may be represented as a sequence of N 2D or 3D waypoints x¹ . . . x^{N}, and the diffusion model 150 may iteratively predict and refine a denoised motion sequence \hat{x}¹ . . . \hat{x}^{N} over a series of t diffusion steps. For example, the denoising component 145 may initially construct a representation of the sequence using one or more data structures that represent position (e.g., 3D positon, a 2D ground projection), orientation, and/or other features of one or more joints of a character at each of the waypoints, populating known parameters (e.g., position and orientation of a starting point x¹) in corresponding elements of the one or more data structures, and populating the remaining elements (e.g., the unknowns to be predicted) with random noise.

FIG. 5 illustrates an embodiment in which the denoising component 145 starts at the last diffusion step t=T, using the diffusion model 150 to predict a denoised motion sequence \hat{x}₀¹ . . . \hat{x}₀^{N} at the first diffusion step t=0. After this first iteration, the denoising component 145 may diffuse the denoised motion sequence to a state corresponding to the one preceding the last diffusion step t=T−1, and use that as an input into the next iteration to again predict a denoised motion sequence \hat{x}₀¹ . . . \hat{x}₀^{N} at the first diffusion step t=0. The denoising component 145 may repeat this process, effectively updating the state of the denoised motion sequence in reverse order from the final diffusion step to the initial one. This reverse diffusion process is meant as an example, and other diffusion techniques with any number and order of diffusion steps may be implemented within the scope of the present disclosure.

In some embodiments, the motion segment denoising control component 160 may segment, crop, partition, split, or otherwise generate expanded noised motion segments 512, 514, 516 corresponding to the expanded temporal intervals for the text prompts 410, 414, 416 of FIG. 4, and may independently apply each expanded noised motion segment to the diffusion model 150 to predict expanded denoised motion segments 522, 524, 526. For example, the motion segment denoising control component 160 may temporally split the noisy motion sequence xₜ into a corresponding (expanded) motion segment for each text prompt. For each interval [aⱼ,bⱼ], the motion segment denoising control component 160 may segment the noisy motion sequence xₜ in time into a motion segment which may be represented by xₜ^{a}^{ⱼ}^{:b}^{ⱼ}=xₜ[aⱼ:bⱼ]. As such, the motion segment denoising control component 160 may apply the motion segment and the corresponding text prompt to the diffusion model 150 to predict a corresponding denoised motion segment \hat{x}₀^{a}^{ⱼ}^{:b}^{ⱼ}. Denoising each text prompt independently yields high-quality motion from pre-trained models, since each prompt typically contains a single action and the duration of the (expanded) temporal interval duration is typically manageable (e.g., less than 10 seconds).

In some embodiments, two or more text prompts in the timeline may overlap in time, meaning their corresponding predicted denoised motion segments will also overlap. For example, suppose the denoised motion segments for “walking in a circle” and “raising right hand” are overlapping as illustrated in FIG. 4. In such a case, it may be not immediately apparent which of the two generated motion segments should be assigned to the overlapping region. To construct a composite motion segment that matches both prompts, it may be desirable to stitch together the leg motion generated in response to the “walking in a circle” prompt and the right arm motion generated in response to the “raising right hand” prompt. As such, in some embodiments, denoised motion segments corresponding to overlapping prompts may be stitched based on corresponding body part labels.

In an example overview with respect to FIGS. 1 and 5, the body part stitching component 170 may assign denoised motion segments to corresponding body part timelines 540 based on the body part labels for corresponding text prompts, the temporal stitching component 180 may stitch the assigned overlapping denoised motion segments within each body part timeline, the body part stitching component 170 may extract motion segments applicable to specific body parts (e.g., based on a known subset of the dimensions of the applicable pose representation corresponding to each body part) from the temporally stitched denoised motion segment from a corresponding body part timeline, and the body part stitching component 170 may combine (e.g., concatenate) the extracted body part motion segments. Since the diffusion model 150 may output a denoised sequence of poses, and the pose representation for any given diffusion model is known, the indices of a pose vector corresponding to the arms, legs, etc. should also be known. As such, the body part stitching component 170 may extract body-part motion segment from full-body motion segments and spatially combine them to obtain a composite motion segment. As such, during each denoising step, the body part stitching component 170 may split each denoised motion segment xₜ^{a}^{ⱼ}^{:b}^{ⱼ} into separated body-part motion segments and may concatenate the separated body-part motion segments together as specified by the body-part timelines 540 to obtain the output \hat{x}₀. Generally, this process may be performed during each denoising step, encouraging a more coherent composition of movements by allowing the diffusion model 150 to correct any artifacts.

In some embodiments, the temporal stitching component 180 may generate denoised motion segments for each of the transition intervals 430 (represented in FIG. 5 on the timelines 550) by applying an unconditioned noised motion segment corresponding to each transition interval to the diffusion model 150. As such, the temporal stitching component 180 may combine scores predicted by the diffusion model for overlapping motion segments (e.g., overlapping conditioned motion segments and an unconditioned motion segment for the corresponding transition interval) to guide the subsequent denoising step.

As such, the denoising component 145 may iterate over any number of denoising step to iteratively refine the motion sequence 190, and the motion sequence 190 may be used to animate the character.

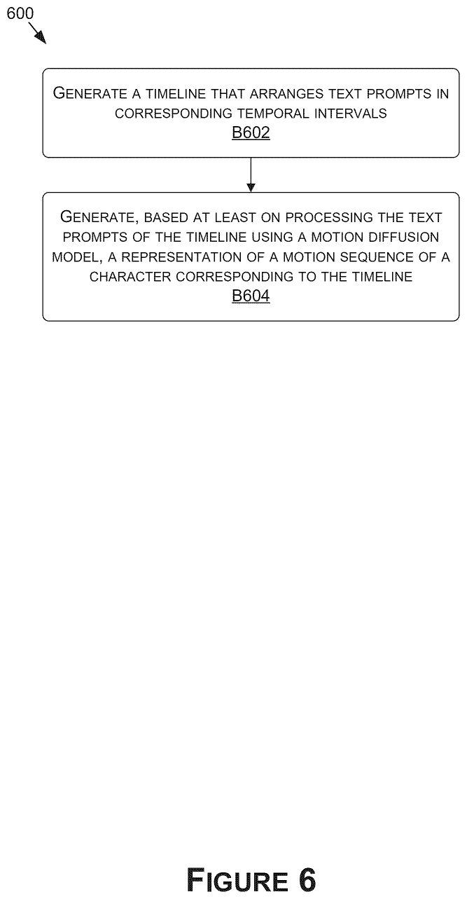

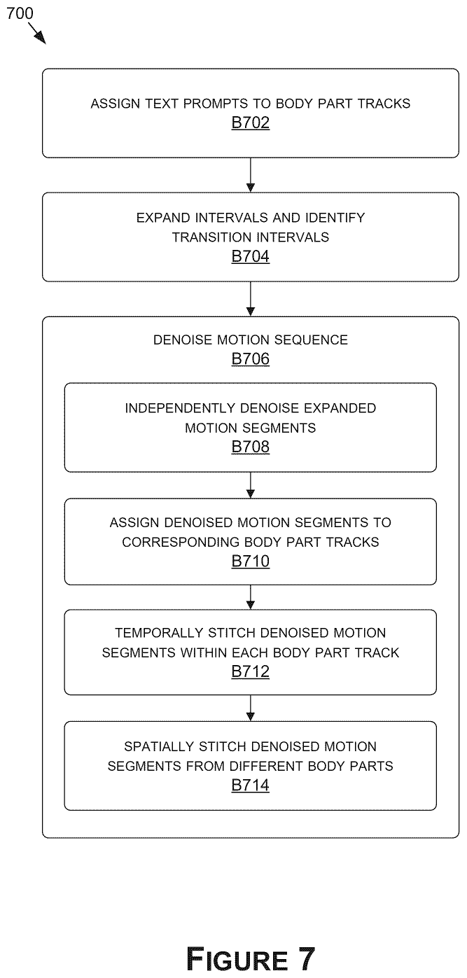

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 600 and 700 are described, by way of example, with respect to the temporally-conditioned simulated motion generation pipeline 100 of FIG. 1. However, these methods 600 and 700 may additionally or alternatively be executed by any one system, or any combination of systems, including, but not limited to, those described herein.

FIG. 6 is a flow diagram illustrating a method 600 of generating a representation of a motion sequence of a character corresponding to a timeline, in accordance with some embodiments of the present disclosure. The method 600, at block B602, includes generating a timeline that arranges text prompts in corresponding temporal intervals. For example, with respect to the temporally-conditioned simulated motion generation pipeline 100 of FIG. 1, the timeline interface component 110 may implement a graphical user interface that exposes a multi-track timeline and accepts input arranging any number of text prompts in corresponding temporal intervals that may overlap. Generally, the timeline interface component 110 may include any known interaction element to facilitate input, arrangement, and editing of text prompts in any number of tracks.

The method 600, at block B604, includes generating, based at least on processing the text prompts of the timeline using a motion diffusion model, a representation of a motion sequence of a character corresponding to the timeline. For example, with respect to the temporally-conditioned simulated motion generation pipeline 100 of FIG. 1, the denoising component 145 may implement an iterative denoising process using the diffusion model 150 to independently denoise motion segments corresponding to each of the text prompts, temporally and/or spatially stitch the resulting denoised motion segments together, and/or iterate over any number of diffusion steps to generate the motion sequence 190 (e.g., a spatio-temporal motion collage).

FIG. 7 is a flow diagram illustrating a method 700 of denoising a motion sequence, in accordance with some embodiments of the present disclosure. The method 700, at block B702, includes assigning text prompts to body part tracks. For example, with respect to the temporally-conditioned simulated motion generation pipeline 100 of FIG. 1, the body part timeline partitioning component 120 may label, assign, or otherwise associate an applicable body part with each text prompt specified by the timeline, partition the timeline into different tracks for different body parts, and populate the resulting body part tracks with applicable text prompts based on corresponding body part labels.

The method 700, at block B704, includes expanding the temporal intervals corresponding to each of the text prompts and identifying transition intervals. For example, with respect to the temporally-conditioned simulated motion generation pipeline 100 of FIG. 1, the transition interval identification component 130 may expand the temporal intervals so adjacent intervals overlap and may identify transition intervals as the expanded portions of the intervals on the timeline.

The method 700, at block B706, includes denoising a motion sequence. Blocks B708-B714 illustrate an example technique for performing at least a portion of block B706. The method 700, at block B708, includes independently denoising expanded motion segments. For example, with respect to the temporally-conditioned simulated motion generation pipeline 100 of FIG. 1, the motion segment denoising control component 160 may use the diffusion model 150 to independently predict a denoised motion segment for the expanded motion segment corresponding to each of the input text prompts.

The method 700, at block B710, includes assigning denoised motion segments to corresponding body part tracks. For example, with respect to the temporally-conditioned simulated motion generation pipeline 100 of FIG. 1, the body part stitching component 170 may assign denoised motion segments to corresponding body part timelines 540 based on the body part labels for corresponding text prompts.

The method 700, at block B712 includes temporally stitching denoised motion segments within each body part track. For example, with respect to the temporally-conditioned simulated motion generation pipeline 100 of FIG. 1, the temporal stitching component 180 may stitch the assigned overlapping denoised motion segments within each body part timeline.

The method 700, at block B714 includes spatially stitching denoised motion segments from different body parts. For example, with respect to the temporally-conditioned simulated motion generation pipeline 100 of FIG. 1, the body part stitching component 170 may extract motion segments applicable to specific body parts (e.g., based on a known subset of the dimensions of the applicable pose representation corresponding to each body part) from a corresponding body part timeline and combine (e.g., concatenate) the extracted body part motion segments.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Computing Device

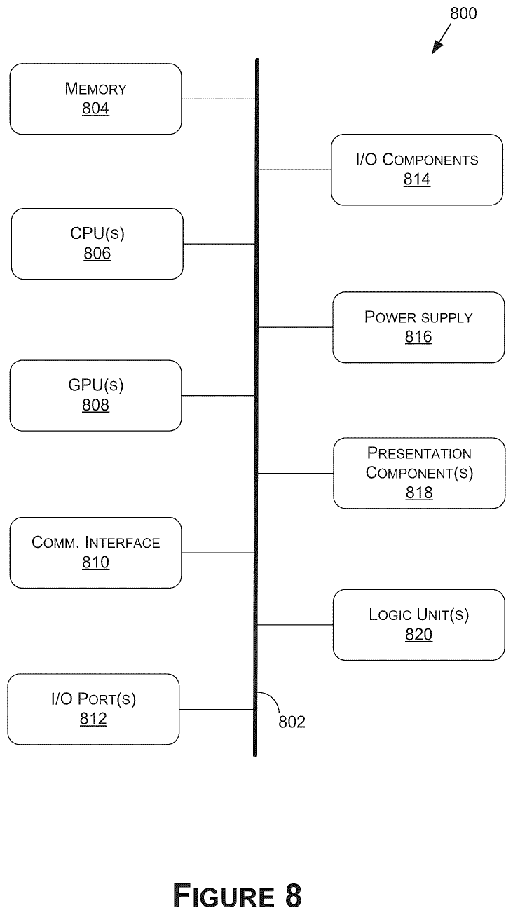

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

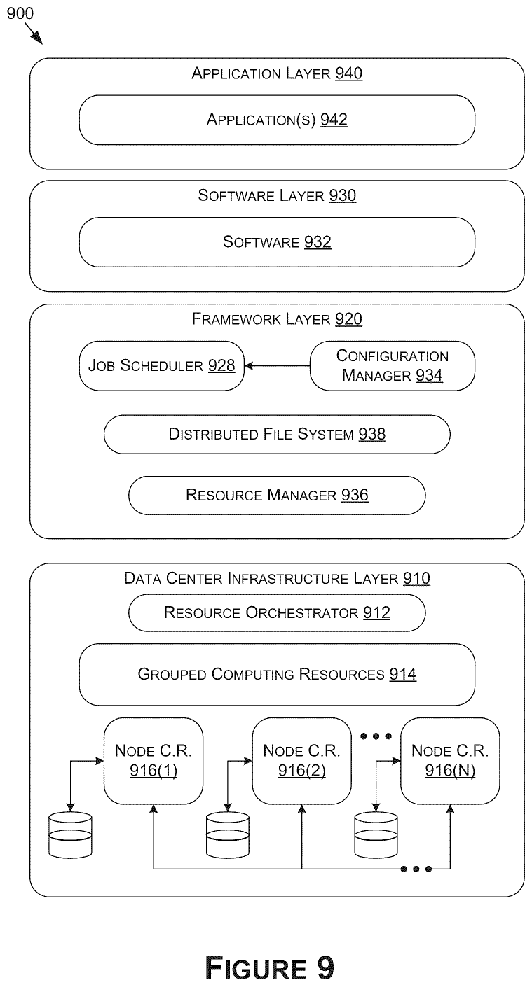

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising one or more processing units to:
generate a timeline that includes an arrangement of text prompts in corresponding temporal intervals; and
generate, based at least on processing the text prompts of the timeline using a diffusion model, a representation of a motion sequence of a character corresponding to the timeline.

2. One or more processors of claim 1, wherein the one or more processing units are further to generate the timeline via a graphical user interface that accepts input representative of the arrangement of the text prompts in a plurality of tracks on the timeline.

3. One or more processors of claim 1, wherein the one or more processing units are further to generate the timeline via a graphical user interface that accepts input specifying a temporal interval for at least one of the text prompts.

4. One or more processors of claim 1, wherein the one or more processing units are further to generate the timeline via a graphical user interface that accepts input specifying a temporal composition of a sequence of the text prompts instructing a sequence of actions to be performed by the character in non-overlapping temporal intervals.

5. One or more processors of claim 1, wherein the one or more processing units are further to generate the timeline via a graphical user interface that accepts input specifying a spatial composition of a set of the text prompts instructing actions to be performed by the character simultaneously with different body parts.

6. One or more processors of claim 1, wherein the one or more processing units are further to use the diffusion model to independently denoise a motion segment for at least one of the text prompts on the timeline in at least one denoising step of one or more denoising steps.

7. One or more processors of claim 1, wherein the one or more processing units are further to spatially and temporally stitch two or more denoised motion segments in at least one denoising step of one or more denoising steps.

8. One or more processors of claim 1, wherein the one or more processing units are further to generate the motion sequence based at least on extracting denoised per-part motion segments associated with different body parts from full-body denoised motion segments associated with corresponding body part tracks and combining the denoised per-part motion segments.

9. One or more processors of claim 1, wherein the one or more processing units are further to expand two or more of the temporal intervals to overlap with each other, generate overlapping denoised segments based at least on denoising an expanded motion segment for at least one of the text prompts on the timeline, and combine the overlapping denoised segments associated with a common body part.

10. The processor of claim 1, wherein the processor is comprised in at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data;
a system for generating synthetic data using AI;
a system incorporating one or more virtual machines (VMs);
a system implemented at least partially in a data center; or
a system implemented at least partially using cloud computing resources.

11. A system comprising one or more processing units to generate, using a diffusion model and based at least on processing a timeline that includes an arrangement of text prompts in corresponding temporal intervals, a timeline-conditioned motion sequence of a character.

12. The system of claim 11, wherein the one or more processing units are further to generate the timeline via a graphical user interface that accepts input representative of the arrangement of the text prompts in a plurality of tracks on the timeline.

13. The system of claim 11, wherein the one or more processing units are further to generate the timeline via a graphical user interface that accepts input specifying a temporal interval for at least one of the text prompts.

14. The system of claim 11, wherein the one or more processing units are further to generate the timeline via a graphical user interface that accepts input specifying a temporal composition of a sequence of the text prompts instructing a sequence of actions to be performed by the character in non-overlapping temporal intervals.

15. The system of claim 11, wherein the one or more processing units are further to generate the timeline via a graphical user interface that accepts input specifying a spatial composition of a set of the text prompts instructing actions to be performed by the character simultaneously with different body parts.

16. The system of claim 11, wherein the one or more processing units are further to use the diffusion model to independently denoise a motion segment for at least one of the text prompts on the timeline in at least one denoising step of one or more denoising steps.

17. The system of claim 11, wherein the one or more processing units are further to spatially and temporally stitch denoised motion segments in at least one denoising step of one or more denoising steps.

18. The system of claim 11, wherein the system is comprised in at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
generate an arrangement of text prompts in corresponding temporal intervals; and
generate, based at least on processing the text prompts using a diffusion model, a representation of a motion sequence of a character implementing the arrangement of the text prompts.

20. The method of claim 19, wherein the method is performed by at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data;
a system for generating synthetic data using AI;
a system incorporating one or more virtual machines (VMs);
a system implemented at least partially in a data center; or
a system implemented at least partially using cloud computing resources.
